(19) United States
(12) Patent Application Publication
(10) Pub. No.: US 2011/0261726 A1
(43) Pub. Date: Oct. 27, 2011

(54) Emergency Call in Radio System

(76) Inventors: Hannu Tapio Hakkinen, Espoo (FI); Petri Olavi Jappila, Helsinki (FI); Sanna Maria Maenpaa, Espoo (FI)

(21) Appl. No.: 13/128,129

(22) PCT Filed: Nov. 7, 2008
(86) PCT No.: PCT/EP2008/065132

§ 371 Date: Jul. 5, 2011

(51) Int. Cl. H04W 4/22

(52) U.S. Cl. 370/259

(57) ABSTRACT

Emergency call processing in apparatuses, methods, and computer programs is disclosed. A terminal and a base station include processors configured to have a packet-switched radio resource control connection between the terminal and the network, and to make/perform an emergency call through the network while continuing to have the packet-switched radio resource control connection.

### FIELD

The invention relates to emergency calls in radio systems.

### BACKGROUND

Emergency calls are made in case of extreme urgency. Consequently, reliability of emergency calls should be high: connection times should be as short as possible, and call drop-off rates should be quite low, for example. In summary, emergency call implementation into a radio system requires utmost care.

### BRIEF DESCRIPTION

The present invention seeks to provide improved emergency call processing in apparatuses, methods, and computer programs.

According to an aspect of the present invention, there is provided an apparatus as specified in claim 1.

According to another aspect of the present invention, there is provided another apparatus as specified in claim 8.

According to another aspect of the present invention, there is provided a method as specified in claim 16.

According to another aspect of the present invention, there is provided a computer program as specified in claim 22.

According to another aspect of the present invention, there is provided another method as specified in claim 23.

According to another aspect of the present invention, there is provided another computer program as specified in claim 30.

According to another aspect of the present invention, there is provided a computer program on a carrier as specified in claim 31.

According to another aspect of the present invention, there is provided another computer program on a carrier as specified in claim 32.

According to another aspect of the present invention, there is provided another apparatus as specified in claim 33.

According to another aspect of the present invention, there is provided another apparatus as specified in claim 34.

### LIST OF DRAWINGS

Embodiments of the present invention are described below, by way of example only, with reference to the accompanying drawings, in which

FIGS. 1 and 2 illustrate embodiments of both a terminal and a network of a radio system;

FIGS. 3, 4, 5, 6, 7, and 8 illustrate emergency call signal-sequences between the terminal and the network;

FIG. 9 is a flow-chart illustrating embodiments of a method applicable to the terminal; and

FIG. 10 is a flow-chart illustrating embodiments of a method applicable to the network.

### DESCRIPTION OF EMBODIMENTS

The following embodiments are exemplary. Although the specification may refer to an embodiment or embodiments in several locations, this does not necessarily mean that each such reference is to the same embodiment(s), or that the feature only applies to a single embodiment. Single features of different embodiments may also be combined to provide other embodiments. The present invention is applicable to any radio system that supports the functionality that will be described in the following. The protocols and specifications of radio systems develop rapidly. Such development may require extra changes to an embodiment. Therefore, all words and expressions should be interpreted broadly and they are intended to illustrate, not to restrict, the embodiment.

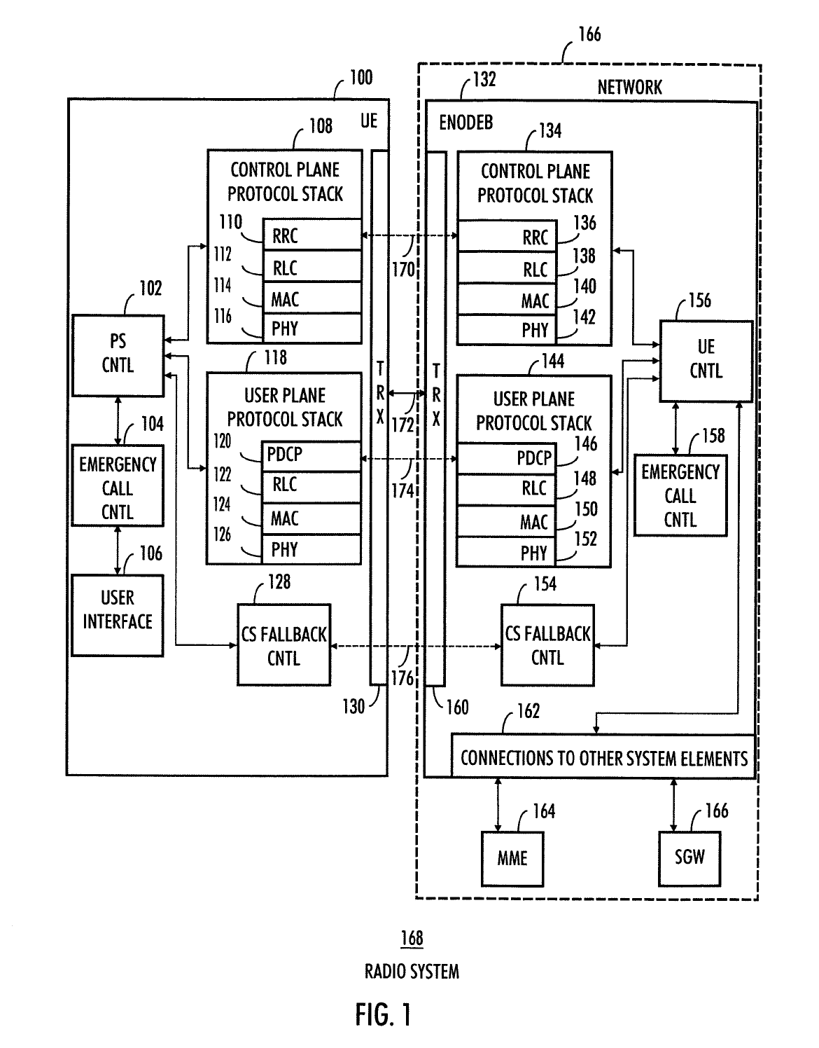

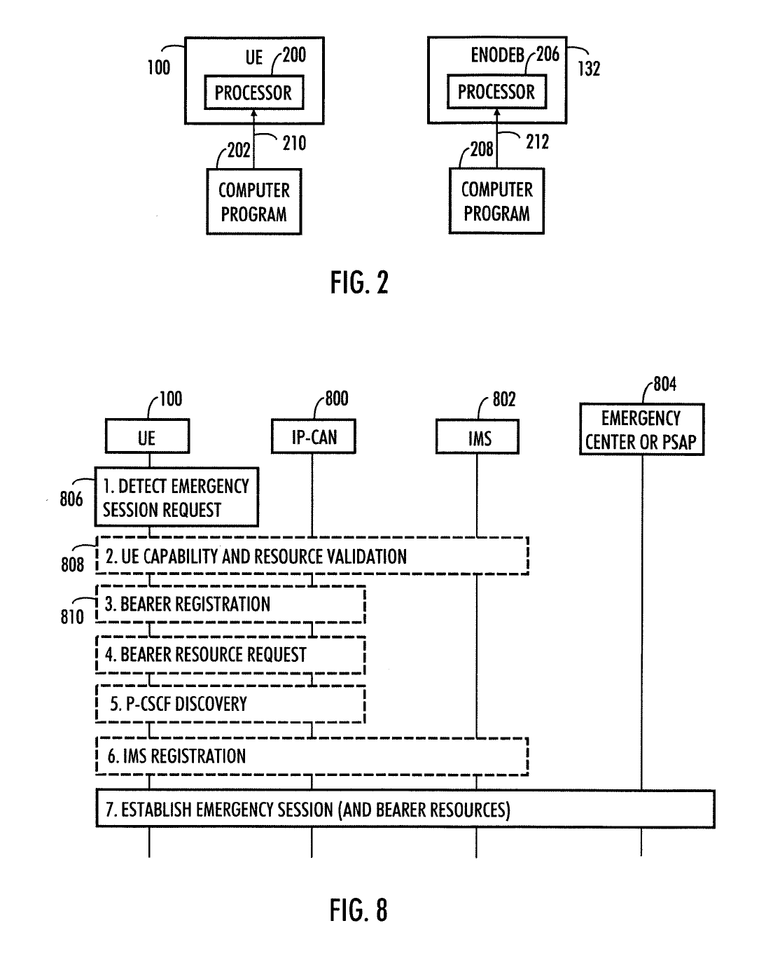

FIGS. 1 and 2 only show some elements and functional entities, all being logical units whose implementation may differ from what is shown. The connections shown in FIGS. 1 and 2 are logical connections; the actual physical connections may be different. Interfaces between the various elements may be implemented with suitable interface technologies, such as a message interface, a method interface, a sub-routine call interface, a block interface, or any means enabling communication between functional sub-units. It should be appreciated that apparatuses may comprise other units. However, they are irrelevant to the actual invention and, therefore, they need not be discussed in more detail herein. It is also to be noted that although some elements are depicted as separate, some of them may be integrated into a single physical element.

FIG. 1 illustrates the main parts of any radio system 168: a terminal 100, and a network 166. The radio system 168 provides packet-switched wireless radio connections 172 between the terminal 100 and the network 166. A non-exhaustive list of suitable radio systems 168 include the following: a third-generation (3G) radio system, a third-generation Partnership Project (3GPP) radio system, a 3GPP Long Term Evolution (LTE) radio system, and a fourth-generation (4G) radio system. In addition to these standard radio systems, non-standard and proprietary radio systems may provide suitable platforms for the embodiments to be described.

A ‘terminal’ 100 refers to a user terminal operating with or without a subscriber identification module (SIM). Such a terminal 100 may be portable, or, in certain cases it may be fixed to a certain location (within a house, for example) or an object (a car-mounted terminal, for example). The terminal 100 may also be known by the following names, for example: a mobile station, a mobile phone, a smartphone, a personal digital assistant (PDA), user equipment (UE), and a subscriber terminal. The terminal 100 is configured to associate the terminal and its user with a subscription, and to allow the user to interact with the radio system 168. The terminal 100 presents information to the user and allows the user to input information. In other words, the terminal 100 may be any terminal capable of receiving information from and/or transmitting information to the network 166 and connectable to the network 166 wirelessly.

The ‘network’ 166 refers to the fixed network infrastructure of the radio system. The network 166 may be operated by the network operator. The network 166 may also be known by the following names, for example: a cellular radio network, and a mobile network. The network 166 comprises a number of system elements. Three such system elements are illustrated in FIG. 1: a base station 132, a mobile management entity (MME) 164, and a serving gateway (SGW) 166. As illustrated in FIG. 1, the base station 132 may comprise suitable equipment 162 enabling (wired or wireless) connections to the other system elements. The base station 132, implementing the actual radio interface (or air interface) 172 to the terminal 100, may also be known by other names, for example: a base transceiver station, and eNodeB.

The radio interface 172 is implemented by radio transceivers 130, 160 operating both in the terminal 100 and in the base station 132. In the LTE, for example, the downlink radio interface 172 is implemented with OFDMA (Orthogonal Frequency-Division Multiple Access), and the uplink radio interface 172 is implemented with SC-FDMA (Single-carrier Frequency-Division Multiple Access).

As illustrated in FIG. 2, the terminal 100 comprises a processor 200, and the base station 132 also comprises a processor 206. The term ‘processor’ refers to a device that is capable of processing data. The processor 200, 206 may comprise an electronic circuit(s) implementing the required functionality, and/or a microprocessor(s) running a computer program implementing the required functionality. When designing the implementation, a person skilled in the art will consider the requirements set for the size and power consumption (of the terminal 100, and of the base station 132), the necessary processing capacity, production costs, and production volumes, for example.

The electronic circuit(s) may comprise logic components, standard integrated circuits, and/or application-specific integrated circuits (ASIC).

The microprocessor implements functions of a central processing unit (CPU) on an integrated circuit. The CPU is a logic machine executing a computer program which comprises program instructions. The program instructions may be coded as a computer program using a programming language, which may be a high-level programming language, such as C, or Java, or a low-level programming language, such as a machine language, or an assembler. The CPU may comprise a set of registers, an arithmetic logic unit (ALU), and a control unit. The control unit is controlled by a sequence of program instructions transferred to the CPU from a program memory. The control unit may contain a number of microinstructions for basic operations. The implementation of the microinstructions may vary, depending on the CPU design. The microprocessor may also have an operating system (a dedicated operating system of an embedded system, or a real-time operating system), which may provide system services to the computer program.

FIG. 2 illustrates computer programs 202, 208 run on the processors 200, 206. The computer program may comprise subroutines, methods, macros, applets, classes, objects, or any other parts forming the software. The computer program 202, 208 may be in source code form, object code form, or in some intermediate form, and it may be stored on some sort of carrier, which may be any entity or device capable of carrying 210, 212 the computer program 202, 208 to the terminal 100 and the base station 132. The carrier may be implemented as follows, for example: the computer program 202, 208 may be embodied on a record medium, stored in a computer memory, embodied in a read-only memory, carried on an electrical carrier signal, carried on a telecommunications signal, and/or embodied on a software distribution medium.

The processor 200 of the terminal 100 is configured to have a packet-switched (PS) radio resource control (RRC) connection 170 with the network 166 (or, more specifically, with the base station 132). Furthermore, the processor 200 of the terminal 100 is configured to make an emergency call through the network 166 while continuing to have the packet-switched radio resource control connection 170 with the network 166.

Correspondingly, the processor 206 of the base station 132 is configured to have a packet-switched radio resource control connection 170 with the terminal 100, and to perform an emergency call originated by the terminal 100 while continuing to have the packet-switched radio resource control connection 170 with the terminal 100.

The radio resource control connection 170 may refer to a point-to-point bidirectional connection between the RRC control entities 110, 136 on the terminal 100 and the base station 132.

In principle, it could be possible to drop the existing packet-switched radio resource control connection 170, and establish a new packet-switched radio resource control connection. However, such action would cause severe problems in emergency call situations: an emergency caller cannot continue to use existing services or at least they will be affected. This is a really unwanted situation. The emergency call system has not yet been fully defined for the LTE. It is planned to be agreed in 3GPP release 9. It may become a mandatory part for the LTE systems, when handheld terminals with voice calls are implemented. In the LTE system, many terminals may have always on connections, and they may be in the radio resource connection connected state. LTE is also a PS only system, and the current 3G CS emergency call procedures do not solve the emergency call prioritization. Another problem is that some networks may support emergency VoIP calls and some networks may deploy a CS domain for emergency calls. The emergency call needs to be correctly handled for a given single terminal 100 in both network types. It is also complex to update the service strategy in the network 166, because the current mechanisms require that the terminal 100 and/or the network 166 need to be updated as a result of the radio access and/or core network changes in the used network.

Next, some use cases relating to an emergency call will be presented.

Use case 1: An IMS- or VoIP-based emergency call. IMS (Internet Protocol Multimedia Subsystem) refers to the provision of Internet Protocol multimedia to mobile users. VoIP (Voice over Internet Protocol) refers to the delivery of voice communications over the Internet (or other packet-switched networks). Other, synonymous terms for VoIP may also be used, such as IP telephony and Internet telephony, voice over broadband, broadband telephony, and broadband phone. Let us suppose that the terminal 100 is using a default bearer for SIP (Session Initiation Protocol, used for setting up and tearing down voice and video calls over the Internet) signalling. If the terminal 100 needs to send SIP signalling to the network 166 in an overload situation, the terminal 100 may not be able to send even the first SIP signalling message towards the network, if the terminal 100 is not prioritized. Because of that, the packet-switched radio resource control connection 170 needs to be updated before the network 166 even tries to guarantee that the terminal 100 can send the first SIP signalling message to create the emergency call.

Use case 2: A young girl has hurt herself and calls her mother for help. The mother wants to keep the call with her daughter ongoing (in order to calm her, to check her location, or to see the situation provided that the call is a video call), while at the same time calling an emergency centre. Another alternative is to put the call with the daughter on hold. Even in that situation, it is beneficial to keep the packet-switched radio resource control connection 170 active all the time. The call between the mother and daughter may even be a proprietary (such as a Skype call) or IMS/VoIP call. If the packet-switched radio resource control connection 170 was dropped, the call between the mother and daughter would also be dropped.

Use case 3: A man is driving the car and an accident happens. He does not know his location. He uses a map application in his terminal 100 to see his location, because he wants to make the accident location known to the emergency centre. The dropping of the packet-switched radio resource control connection 170 would either drop the map application or at least make its operation much slower.

Use case 4: A user is using multiple services at the same time, and suddenly there is a need to make an emergency call. If the packet-switched radio resource control connection 170 was dropped, the used applications would notice that and start to send multiple messages to check whether the connection is in order. This would lead to excessive messaging, creating unwanted load both to the terminal 100 and the network 166 just when the emergency call is to be made. Keeping the existing packet-switched radio resource control connection 170 working all the time results in that the task of the terminal 100 during the emergency call becomes much easier. The terminal 100 does not need to check whether the packet-switched radio resource control connection 170 needs to be dropped or not, neither does it need to implement specific handling (what to do if the packet-switched radio resource control connection is dropped due to an emergency call) for every application. The terminal 100 may always merely update the packet-switched radio resource control connection 170, whereupon the base station 132 may allocate resources (more scheduling resources to guarantee that the terminal can make the actual emergency call, for example) to that terminal 100. Dropping the packet-switched radio resource control connection 170 can also cause that the base station 132 will drop the terminal 100 (LTE-IDLE) and also drop the EPS (Evolved Packet Systems) bearer. This can happen especially in the overload situation, or if the network operator wants to minimize the EPS bearer usage (if the pricing model between the network vendor and the operator is partly based on the number of EPS bearers, for example). This will lead to unnecessary signalling and problems for the existing services. The additional signalling will also take more time (especially in an overload situation) and increase the risk that an emergency call cannot be made at all.

In the embodiment of FIG. 1, both the terminal 100 and the base station 132 have a control plane protocol stack 108, 134 and a user plane protocol stack 118, 144.

The control plane protocol stack 108, 134 has the following layers:
a physical layer 116, 142 with the following tasks, for example: FEC encoding/decoding, error detection, support of hybrid-ARQ, modulation/demodulation, frequency and time synchronization, power control, antenna diversity, and MIMO;
a medium access control (MAC) layer 114, 140 with the following tasks, for example: mapping and multiplexing of logical channels to transport channels, traffic volume measurement reporting, hybrid-ARQ, and priority handling;
a radio link control (RLC) layer 112, 138 with the following tasks, for example: retransmission control (ARQ), segmentation, and flow control towards a gateway; and
a radio resource control (RRC) layer 110, 136 with the following tasks, for example: broadcast of system information, radio connection, radio bearers, paging, handovers, QoS management, and radio measurement control.

In a protocol stack, a lower layer provides services for an upper layer. For the sake of clarity, only a logical connection 170 between the RRC layer 110 of the terminal 100 and the RRC layer 136 of the base station 132 has been illustrated, but other layers also have such connections: 112<->138, 114<->140, and 116<->142. When the logical connection 170 exists, it may be said that the terminal 100 is in an RRC connected state.

The user plane protocol stack 118, 144 has the following layers:
a physical layer 126, 152;
a medium access control (MAC) layer 124, 150;
a radio link control (RLC) layer 122, 148; and
a packet data convergence protocol (PDCP) layer 120, 146 with the following tasks, for example: IP header compression and decompression, and transfer of user data.

Again, for the sake of clarity, only a logical connection 174 between the PDCP layer 120 of the terminal 100 and the PDCP layer 146 of the base station 132 has been illustrated.

In the embodiment of FIG. 1, the terminal 100 further comprises a packet-switched controller 102, an emergency call controller 104, and a user interface 106. When making an emergency call, the user manipulates the terminal 100 through its user interface 106, whereby the emergency call controller 104 starts to establish a data transfer connection to the called party with the packet-switched controller 102. The packet-switched controller 102 utilizes the control plane protocol stack 108 in order to manipulate the RRC connection 170, if needed, and to establish a data transfer connection to the called party through the user plane protocol stack 118, or to utilize a circuit-switched 176 fallback controller 128, as will be explained later.

Correspondingly, in the embodiment of FIG. 1, the base station 132 further comprises an emergency call controller 158 interacting with a terminal controller 156. When receiving a request for a mobile-originated emergency call, the terminal controller 156 provides the needed information for the emergency call controller 158, and decides how to use the protocol stacks 134, 144, and possibly a circuit-switched 176 fallback controller 154.

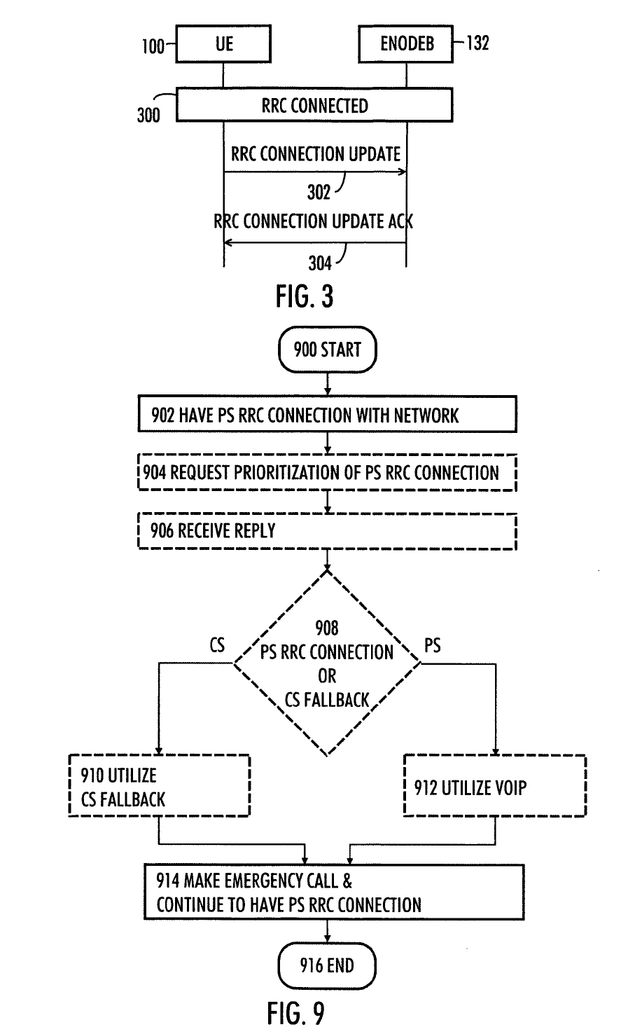

Next, various embodiments are described with reference to FIGS. 3, 4, 5, 6, 7, and 8, which illustrate emergency call signal-sequences between the terminal 100 and the network 166. The signalling messages are only exemplary and may even comprise several separate messages for transmitting the same information. In addition, the messages may also contain other information.

In an embodiment, illustrated in FIG. 3, the processor 200 of the terminal 100 is further configured to transmit a request 302 to the network 166 to prioritize the packet-switched radio resource control connection 170 due to the emergency call. The processor 206 of the base station 132 is further configured to receive the request 302 from the terminal 100 to prioritize the packet-switched radio resource control connection 170 due to the emergency call. A prerequisite is that the terminal 100 is in an RRC connected state 300.

In an embodiment, also referred to in the use cases, the processor 206 of the base station 132 is further configured to prioritize the packet-switched radio resource control connection 170 due to the request 302. Both processors 200, 206, may be configured to perform the signalling of the emergency call with the prioritized packet-switched radio resource control connection 170.

As can be seen from FIG. 3, the processor 206 of the base station 132 may be configured to transmit a reply 304 to the terminal 100, and the processor 200 of the terminal 100 may be configured to receive the reply 304 from the network 166. The reply 304 may indicate that the signalling of the emergency call is to be performed for a voice over Internet Protocol (VoIP) session. The reply 304 may also indicate that the signalling of the emergency call is to be performed for a circuit-switched (CS) fallback.

The request 302 may be implemented as a new RRC connection update message, and the reply 304 may be implemented as a new RRC connection update acknowledgement message. The RRC connection update 302 may be a logical message to update an RRC connection, and it may be a separate new/existing message, or it may be integrated to existing and/or new messages, and the values in the message(s) may be new, updated, or existing. The RRC connection update acknowledgement 304 may be an optional logical acknowledgement message to update the RRC connection, and it may be a separate new/existing message, or it may be integrated to the existing/new messages, and the values in the message(s) may be new, updated, or existing.

A VoIP emergency call has been defined for the LTE, as illustrated in FIG. 8, which has been taken from 3GPP TS23.167 specification, V8.1.0 (2008-09), chapter 7.1.1 UE Detectable Emergency Session, incorporated herein by reference. Besides the earlier described system elements, the following system elements are depicted: IP-CAN (IP-Connectivity Access Network) 800, IMS (IP Multimedia Subsystem) 802, and an emergency centre or PSAP (Public Safety Answering Point) 804. In 806, the terminal 100 detects the request for the establishment of an emergency session. In 808, if the terminal 100 has insufficient resources or capabilities to establish an emergency call due to other ongoing sessions, the terminal 100 should terminate the ongoing sessions and release reserved bearer resources. In 810, if bearer registration is required and has not been performed, the terminal 100 shall perform the bearer registration to the IP-CAN 800, but if the terminal 100 is already bearer-registered, the bearer registration procedures are not required. The RRC connection update 302 may be implemented somewhere between operations 806 and 808, for example before or after operation 808 or within operation 808.

The CS fallback enables the provisioning of voice and other CS-domain services by reuse of CS infrastructure when the terminal 100 is served by EUTRAN (Evolved Universal Terrestrial Radio Access) of the LTE. A CS fallback enabled terminal 100 may use GERAN (GSM EDGE Radio Access Network) or UTRAN (Universal Mobile Telecommunications System Terrestrial Radio Access Network) to establish one or more CS-domain services.

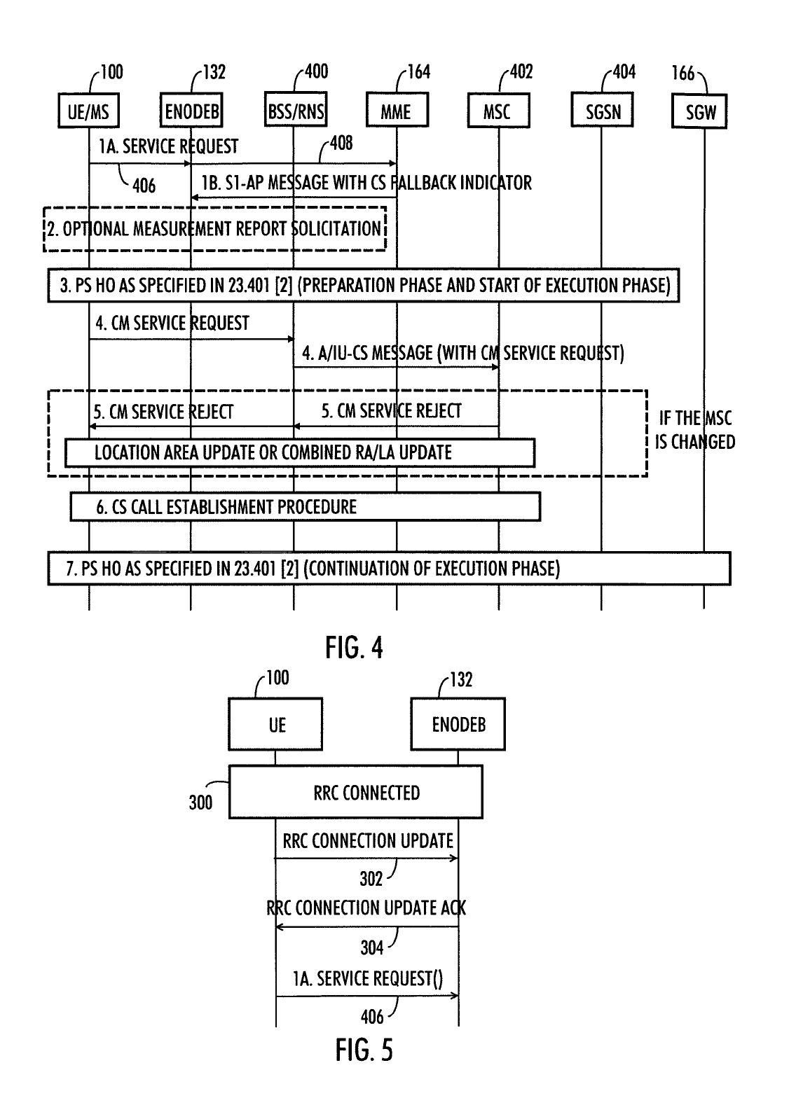

A CS fallback (CSFB) solution has been defined for the LTE, as illustrated in FIG. 4, which has been taken from 3GPP TS23.272 specification, V8.1.0 (2008-09), chapter 6.2 Mobile originating call in Active mode—PS HO supported, incorporated herein by reference. Besides the earlier described system elements, the following system elements are depicted: BSS/RNS (Base Station Subsystem/Radio Network Subsystem) 400, MSC (Mobile Switching Centre) 402, and SGSN (Serving General Packet Radio Service Support Node) 404. A service request is transmitted 406 from the terminal 100 to the base station 132, and the base station 132 forwards 408 the service request transparently to the MME 164. The service request message is encapsulated in RRC and S1-AP messages.

As illustrated in FIG. 5, the base station 132 may initiate CS fallback after receiving the RRC connection update 302. The base station 132 may indicate to the terminal 100 in the RRC connection update acknowledgement 304 that a CS fallback should be started. The base station 132 may allocate, already after the reception of the RRC connection update 302, the needed resources to guarantee that the service request 406 can be transmitted to the MME 164. This secures the prioritization of the emergency call so that it will get adequate resources, even in an overload situation. The processor 200 of the terminal 100 may be configured to transmit the service request 406 for the emergency call with the prioritized packet-switched radio resource control connection 170, and the processor 206 of the base station 132 may be configured to receive the service request 406 for the emergency call with the prioritized packet-switched radio resource control connection 170.

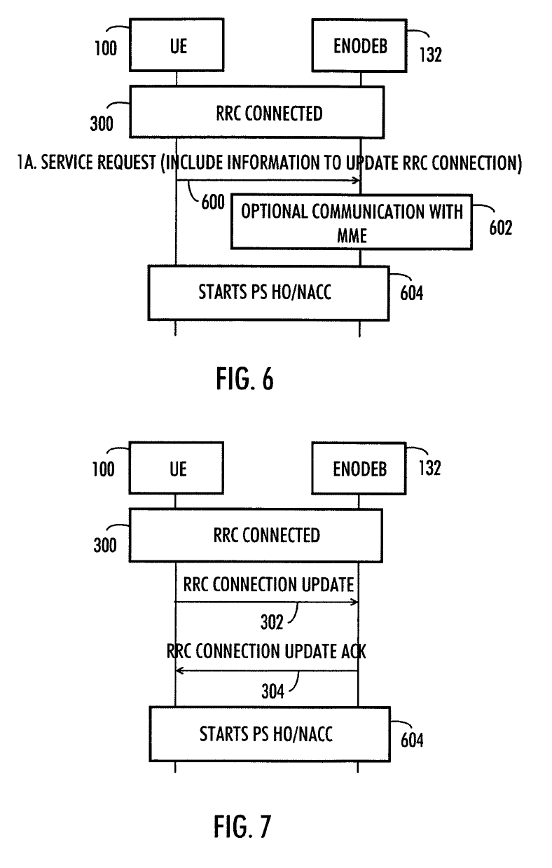

FIG. 6 illustrates an embodiment where an existing message is used to update the RRC connection. The RRC connection update message 302 of FIG. 5 is implemented inside the 1a service request 600. The base station 132 may allocate the needed resources to guarantee that the service request can be sent to the MME in 602, before the PS HO (handover)/NACC (Network Assisted Cell Change) is started. The communication 602 with the MME 602 may be optional, i.e. the base station 132 may not necessarily transfer the 1a service request 600 to the MME 164 as in FIG. 4.

FIG. 7 illustrates that with an RRC connection update 302, the base station 132 may move the terminal 100 to another radio access, even without communication with the MME. The base station 132 may start PS HO or NACC procedures 604 with current or improved messages. Additionally, it may even be possible to use an RRC connection update acknowledgement message 304 to direct the terminal 100 to another access.

Next, the use of the RRC connection update 302 is examined.

RRC Connection Update Usage—VoIP/CS Call

RRC connection update 302 provides means to correctly handle emergency calls for the terminal: if CSFB is to be deployed for emergency calls, this may be indicated in the RRC connection update acknowledgement message 304. If emergency VoIP is to be deployed, the RRC connection update procedure is only utilized for increasing the priority of the RRC connection 170. This removes the burden from the terminal 100 for making a decision on what kind of emergency call should be initiated in each network, and the network 166 becomes responsible for this in a controlled way without stating an additional requirement for the terminal 100 implementation, and allowing smooth evolution towards emergency VoIP (i.e. initially the RRC connection update is utilized for indicating a need for CSFB, but later this indication may be removed, when emergency VoIP is supported).

RRC Connection Update Usage—Radio Access Network Updates

Currently, the terminal 100 needs to select the used radio access before sending a service request to the base station 132. This leads to a situation where the terminal 100 needs to know the access strategy for voice calls (including emergency calls). This leads to a situation where it is complex to update a voice strategy, i.e. what access (e.g. LTE/2G) to use. This is even more complex in roaming cases, but a similar problem exists even in the home network. This leads to a situation where the terminal 100 needs to be updated in order to change its behaviour, when the operator wants to start to prioritize calls (voice/emergency).

RRC Connection Update Usage—Roaming Users (Emergency Call)

It is difficult for the MME 164 to know, what the terminal 100 should do (what access to use) in the visited network. It requires constant updates between the home and visited networks concerning the used access network. The described embodiments allow the update of the visited network structure without constant updates between the home and visited networks.

In short, the RRC connection update 302 provides means to correctly handle emergency calls for the terminal 100: if CSFB is to be deployed for emergency calls, this may be indicated in the RRC connection update acknowledgement message 304. If emergency VOIP is to be deployed, the RRC connection update procedure may only be utilized for increasing the priority of the RRC connection 170.

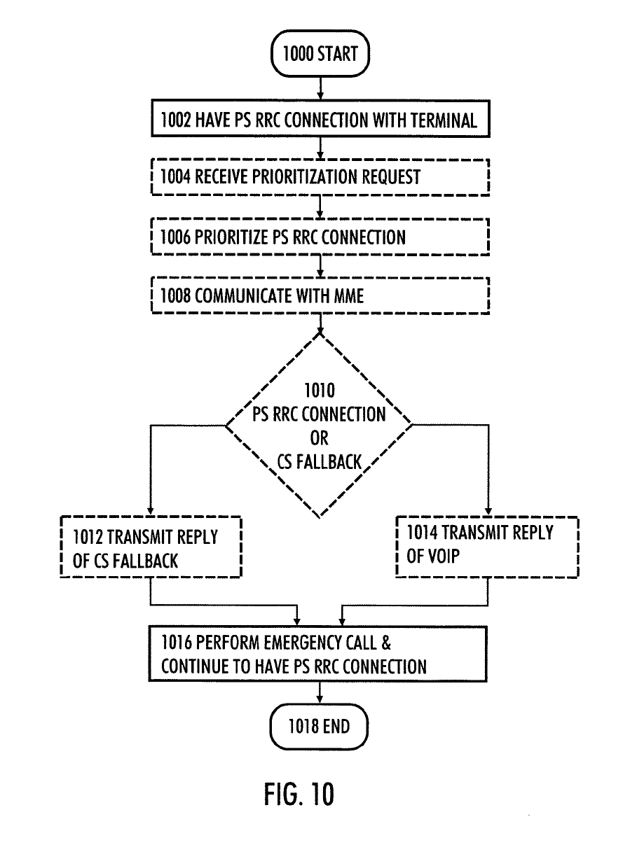

Next, two methods will be described with reference to FIGS. 9 and 10. The operations are in no absolute chronological order, and some of the operations may be performed simultaneously or in an order differing from the given one. Other operations can also be executed between the operations or within the operations. Some of the operations or parts of the operations can also be left out or replaced by a corresponding operation or part of the operation. Earlier described embodiments of the terminal 100 and the network 166 may be applied to these two methods as well.

The method of FIG. 9 is applicable to a terminal. The method starts in 900.

In 902, there is a packet-switched radio resource control connection with a network.

Optionally, in 904, a request may be transmitted to the network to prioritize the packet-switched radio resource control connection due to the emergency call. The request may be an RRC connection update message.

Optionally, in 906, a reply to the request may be received. The reply may be an RRC connection update acknowledgement message.

Optionally, in 908, a control point is defined: whether emergency VoIP session establishment over the prioritized RRC connection takes place or whether a CSFB procedure shall be deployed for an emergency call. This may be decided by studying a received RRC connection update acknowledgement message.

In an embodiment, the signalling of the emergency call may be performed with the prioritized packet-switched radio resource control connection. This means that both the signalling of the emergency call for a circuit-switched fallback and the signalling of the emergency call for a voice over Internet Protocol session may be performed with the prioritized packet-switched resource control connection.

In an embodiment, a service request for the emergency call may be transmitted with the prioritized packet-switched radio resource control connection.

Optionally, in 910, a reply is received from the network, indicating that the signalling of the emergency call is to be performed for a circuit-switched fallback.

Optionally, in 912, a reply is received from the network, indicating that the signalling of the emergency call is to be performed for a voice over Internet Protocol session.

In 914, an emergency call is made through the network while continuing to have the packet-switched radio resource control connection with the network.

The method ends in 916.

The method of FIG. 10 is applicable to a network. The method starts in 1000.

In 1002, there is a packet-switched radio resource control connection with a terminal.

Optionally, in 1004, a request is received from the terminal to prioritize the packet-switched radio resource control connection due to the emergency call.

Optionally, in 1006, the packet-switched radio resource control connection is prioritized due to the request.

Optionally, in 1010, it is decided whether emergency VoIP session establishment over the prioritized RRC connection takes place, or whether a CSFB procedure shall be deployed for an emergency call.

In an embodiment, the signalling of the emergency call is performed with the prioritized packet-switched radio resource control connection.

In an embodiment, a service request for the emergency call may be received with the prioritized packet-switched radio resource control connection.

Optionally, in 1014, a reply is transmitted to the terminal indicating that the signalling of the emergency call is to be performed for a voice over Internet Protocol session.

Optionally, in 1012, a reply is transmitted to the terminal indicating that the signalling of the emergency call is to be performed for a circuit-switched fallback.

In 1016, an emergency call originated by the terminal is performed while continuing to have the packet-switched radio resource control connection with the terminal.

The base station may perform the needed processing alone, or other system elements may also be involved. FIG. 10 illustrates that the base station may optionally communicate with the MME in 1008. Sufficient resources may be allocated for this communication with the MME. The actual prioritization request may be terminated in the base station, but a possible service request for the emergency call may transparently be transmitted to the MME.

The method ends in 1018.

It will be obvious to a person skilled in the art that, as technology advances, the inventive concept can be implemented in various ways. The invention and its embodiments are not limited to the examples described above but may vary within the scope of the claims.

1. An apparatus comprising a processor configured
to have a packet-switched radio resource control connection with a network, and
to make an emergency call through the network while continuing to have the packet-switched radio resource control connection with the network.

2. The apparatus of claim 1, wherein the processor is further configured to transmit a request to the network to prioritize the packet-switched radio resource control connection due to the emergency call.

3. The apparatus of claim 2, wherein the processor is further configured to perform the signalling of the emergency call with the prioritized packet-switched radio resource control connection.

4. The apparatus of claim 3, wherein the processor is further configured to receive from the network a reply indicating that the signalling of the emergency call is to be performed for a voice over Internet Protocol session.

5. The apparatus of claim 3, wherein the processor is further configured to receive from the network a reply indicating that the signalling of the emergency call is to be performed for a circuit-switched fallback.

6. The apparatus of claim 2, wherein the processor is further configured to transmit a service request for the emergency call with the prioritized packet-switched radio resource control connection.

7. The apparatus of claim 1, wherein the apparatus is a terminal of a radio system.

8. An apparatus comprising a processor configured
to have a packet-switched radio resource control connection with a terminal, and
to perform an emergency call originated by the terminal while continuing to have the packet-switched radio resource control connection with the terminal.

9. The apparatus of claim 8, wherein the processor is further configured to receive a request from the terminal to prioritize the packet-switched radio resource control connection due to the emergency call.

10. The apparatus of claim 9, wherein the processor is further configured to prioritize the packet-switched radio resource control connection due to the request.

11. The apparatus of claim 10, wherein the processor is further configured to perform the signalling of the emergency call with the prioritized packet-switched radio resource control connection.

12. The apparatus of claim 11, wherein the processor is further configured to transmit to the terminal a reply indicating that the signalling of the emergency call is to be performed for a voice over Internet Protocol session.

13. The apparatus of claim 11, wherein the processor is further configured to transmit to the terminal a reply indicating that the signalling of the emergency call is to be performed for a circuit-switched fallback.

14. The apparatus of claim 10, wherein the processor is further configured to receive a service request for the emergency call with the prioritized packet-switched radio resource control connection.

15. The apparatus of claim 8, wherein the apparatus is a base station of a radio system.

16. A method comprising:
having a packet-switched radio resource control connection with a network; and
making an emergency call through the network while continuing to have the packet-switched radio resource control connection with the network.

17. The method of claim 16, further comprising: transmitting a request to the network to prioritize the packet-switched radio resource control connection due to the emergency call.

18. The method of claim 17, further comprising: performing the signalling of the emergency call with the prioritized packet-switched radio resource control connection.

19. The method of claim 18, further comprising:
receiving from the network a reply indicating that the signalling of the emergency call is to be performed for a voice over Internet Protocol session.

20. The method of claim 18, further comprising: receiving from the network a reply indicating that the signalling of the emergency call is to be performed for a circuit-switched fallback.

21. The method of claim 17, further comprising:
transmitting a service request for the emergency call with the prioritized packet-switched radio resource control connection.

22. A computer program comprising program instructions which, when loaded into an apparatus, cause the apparatus to perform the process of claim 16.

23. A method comprising:
having a packet-switched radio resource control connection with a terminal; and
performing an emergency call originated by the terminal while continuing to have the packet-switched radio resource control connection with the terminal.

24. The method of claim 23, further comprising: receiving a request from the terminal to prioritize the packet-switched radio resource control connection due to the emergency call.

25. The method of claim 24, further comprising: prioritizing the packet-switched radio resource control connection due to the request.

26. The method of claim 25, further comprising: performing the signalling of the emergency call with the prioritized packet-switched radio resource control connection.

27. The method of claim 26, further comprising: transmitting to the terminal a reply indicating that the signalling of the emergency call is to be performed for a voice over Internet Protocol session.

28. The method of claim 26, further comprising: transmitting to the terminal a reply indicating that the signalling of the emergency call is to be performed for a circuit-switched fallback.

29. The method of claim 25, further comprising:
receiving a service request for the emergency call with the prioritized packet-switched radio resource control connection.

30. A computer program comprising program instructions which, when loaded into an apparatus, cause the apparatus to perform the process of claim 23.

31. A computer program on a carrier, comprising program instructions which, when loaded into an apparatus, cause the apparatus
to have a packet-switched radio resource control connection with a network, and
to make an emergency call through the network while continuing to have the packet-switched radio resource control connection with the network.

32. A computer program on a carrier, comprising program instructions which, when loaded into an apparatus, cause the apparatus
to have a packet-switched radio resource control connection with a terminal, and
to perform an emergency call originated by the terminal while continuing to have the packet-switched radio resource control connection with the terminal.

33. An apparatus comprising:
means for having a packet-switched radio resource control connection with a network; and
means for making an emergency call through the network while continuing to have the packet-switched radio resource control connection with the network.

34. An apparatus comprising:
means for having a packet-switched radio resource control connection with a terminal; and
means for performing an emergency call originated by the terminal while continuing to have the packet-switched radio resource control connection with the terminal.
